(19) United States
(12) Patent Application Publication
(10) Pub. No.: US 2001/0013461 A1
(43) Pub. Date: Aug. 16, 2001

(54) Separating system

(76) Inventor: Bart Gerard Boucherie, Izegem (BE)

Correspondence Address: NIXON PEABODY, LLP, 8180 GREENSBORO DRIVE, SUITE 800, MCLEAN, VA, 22102, US

(21) Appl. No.: 09/731,822

(22) Filed: Dec. 8, 2000

(30) Foreign Application Priority Data
Dec. 9, 1999 (DE) 299 21 672.1

(51) Int. Cl. B65G 47/28

(52) U.S. Cl. 198/459.8

(57) ABSTRACT

Separating system for elongated objects provided in bulk such as brush bodies, especially toothbrush bodies, characterized by the combination of a proportioning device that delivers individual objects that have been separated from the group. The separating system according to the invention comprises a selective transport means that conveys several jointly delivered objects at varying speed, thus separating them.

### FIELD OF INVENTION

The invention relates to a separating system for elongated objects provided in bulk such as brush bodies, especially toothbrush bodies, characterized by the combination of a proportioning device that delivers individual objects that have been separated from the group.

### BACKGROUND OF THE INVENTION

Publication DE 295 20 142 already describes a separating device that is especially suitable for toothbrush bodies and that has a multi-stage lifting-conveying means forming a conveying segment rising from the bottom of a receptacle and having a lifting element that can be moved upward and downward in each conveying stage as well as a stationary placement element. The lifting elements push the toothbrush bodies along a vertical guide wall and, in this process, they can come into contact with said wall. Toothbrush bodies that have embedded sections made of elastomeric material or the like tend to jam in the process. Jammed toothbrush bodies, however, can cause operational malfunctions.

### BRIEF SUMMARY OF THE INVENTION

According to the invention, a solution to the problem is achieved by a separating system that consists of a combination of a proportioning device that delivers individual objects that have been separated from the group and of a selective transport device that conveys several jointly delivered objects at varying speeds, thus separating them. Suitable proportioning devices are bunker belts or conveyor belts that can be moved slowly and continuously or intermittently, combinations of both or else vibration buckets that are commonly used as separating devices. Proportioning devices can be designed with structural means in such a way that they are sufficiently selective to be able to feed just one object at a time. Modern brush production machines, however, call for a greater number of toothbrush bodies per unit of time than can be delivered by such a separating device. Therefore, the invention is based on the idea of using a moderately selective proportioning device that separates sufficient objects from the group per unit of time but that can regularly deliver several of the separated objects together, perhaps even simultaneously. Thus, the proportioning device first performs a separation of small subsets from the total group. Then, with the subsequent selective transport device, the—possibly very small—distances between the delivered objects is increased to such an extent that the objects are separated.

In the preferred embodiment of the invention, the selectivity of the proportioning device is adjusted in such a way that regularly more than just one separated object is delivered to the selective transport device. Since the selectivity of a proportioning device can be controlled very well with conventional means, the throughput rate of the separating system can readily be adapted to the requirements of the machine being used for further processing.

In the preferred embodiment, the selective transport device has a cascade of conveying segments. The desired separation of the objects delivered by the proportioning device can be achieved in various ways by means of such a cascade of conveying segments.

If there is a height difference between the consecutive conveying segments, an object—when it moves from one conveying segment to the next one—will first drop, then it will come into contact with the lower conveying segment, which will finally pick up said object. A second object, which might have lain next to the object in question, will never fall at precisely the same moment and be carried along by the lower conveying segment. Any time lag that exists between the objects, no matter how small it may be, will at least be greatly increased during the transfer to the subsequent conveying segment. The same effect will occur during the transfer to the next conveying segment so that, in general, a reliable separation is already achieved, for example, with three or four consecutive conveying segments.

An alternative or additional embodiment is that the transport speeds of the consecutive conveying segments, which are preferably configured as transport belts, increase in the transport direction, so that each subsequent transport segment has a higher transport speed than the transport segment that preceded it. A reliable separation is achieved with this variant even when there is no height difference between the consecutive conveying segments.

Another embodiment lies in that the conveying segments of the cascade that follow in the transport direction each have a greater friction with respect to the objects than the transport segments that preceded it. As soon as an object is carried along by friction by a subsequent conveying segment, it advances past an object that might be lying next to it since the latter will not be conveyed at the exactly same point in time, and this effectuates the separation.

An additional or alternative embodiment consists in the fact that at least one of the transport segments that is followed by at least one additional transport segment has an adjustable transport speed and is equipped with a passage detector for a transported object that causes the transport speed to be temporarily lowered when an object is detected. This temporary lowering of the transport speed brings about a speed differential with respect to the subsequent transport segment, which can be utilized for separation purposes in the already described manner.

### BRIEF DESCRIPTION OF THE DRAWINGS

Additional features and advantages of the invention will become apparent from the following description of advantageous embodiments and from the drawings to which reference is made. The following is shown in the drawings:

FIG. 1—a schematic perspective view of an embodiment of the separating system;

FIG. 2—an enlarged schematic perspective view of the selective transport device used in the separating system; and

FIG. 3—a schematic perspective view of an embodiment variant of the separating system.

### DETAILED DESCRIPTION OF THE INVENTION

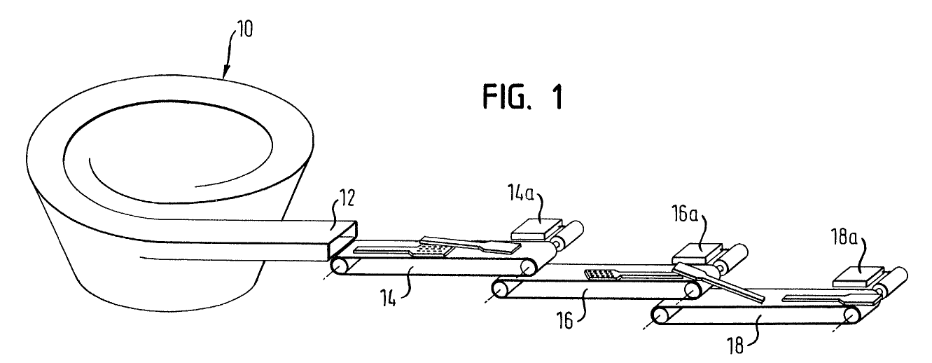

The separating system shown in FIG. 1 is a combination of two components. The first component is a proportioning device that, in the embodiment shown, is configured as a vibration bucket 10 that holds the group of objects. In the embodiment described, it is assumed that the objects are toothbrush bodies. The toothbrush bodies have to be fed individually to a machine for further processing. The vibration bucket 10 has on chute 12 that delivers individual toothbrush bodies that have been separated from the group. The second component of the separating system is a selective transport device consisting of a cascade of consecutive conveying segments, namely, three consecutive conveyor belts 14, 16, 18, between each of which there is a height difference h. Each of the conveyor belts 14, 16, 18 is driven by a drive means 14a, 16a, 18a with a motor. The first conveying segment 14 is immediately adjacent to the chute 12 of the vibration bucket 10, either in one plane or with a height difference.

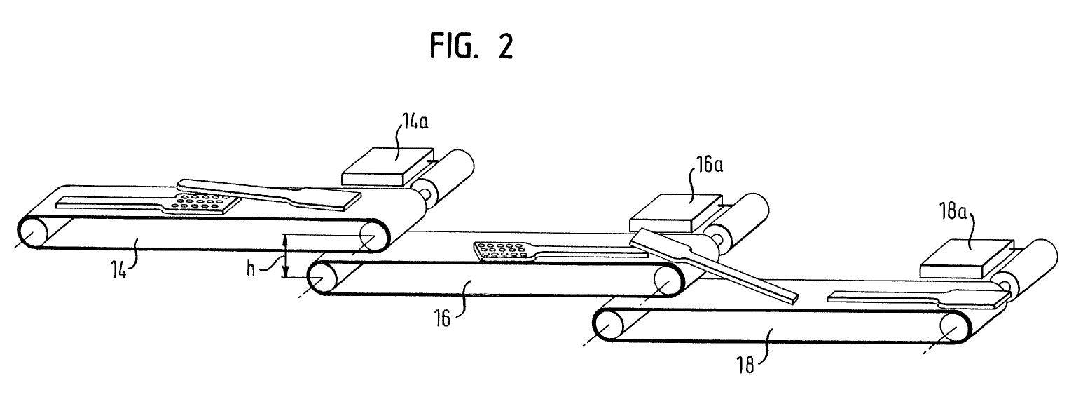

The selectivity of the vibration bucket 10 is adjusted by means of commonly known design measures in such a way that regularly more than just one toothbrush body is delivered at the chute 12. It can happen that two toothbrush bodies are delivered virtually simultaneously at the chute 12 and reach the first conveyor belt 14. In the situation shown in FIG. 2, two toothbrush bodies have been delivered to the conveyor belt 14 just after each other, in such a way that one handle section overlaps with the head section of the other. When the advancing toothbrush body extends over the end of a conveying segment, it drops down towards the next conveying segment, as shown in FIG. 2, at the transition between conveyor belts 16 and 18. These advancing toothbrush bodies are then carried along by the next conveyor belt 18 and thus spatially separated from the subsequent toothbrush body. This separation effect is still considerably enhanced when, according to the preferred embodiment, each subsequent conveyor belt runs faster than the one that precedes it. A speed differential having the same effect can, however, also be achieved in that the passage of a toothbrush body is detected, for instance, by means of a photoelectric barrier, and in response, the speed of the appertaining conveyor belt is temporarily reduced. The motor-powered drive means employed allow such a regulation of the transport speeds.

As an alternative or additionally, the conveyor belts 14 are provided with a transport surface whose friction with respect to the toothbrush bodies is different. The transport belt 14 is relatively smooth, whereas the transport belt 18, for example, due to coating with an elastomer, has a high friction with respect to the toothbrush bodies.

In each of the embodiments described, the result is that several toothbrush bodies delivered by the vibration bucket together and possibly even almost simultaneously are further transported at different speeds and are separated in this manner.

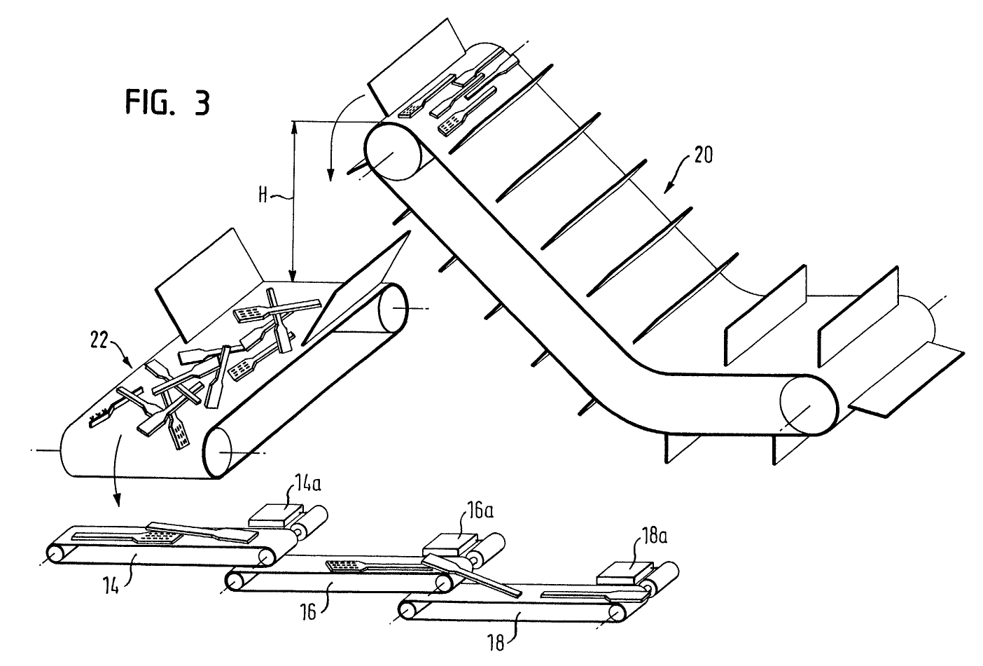

According to another embodiment variant, instead of the vibration bucket 10, a proportioning device of the type of a continuously or intermittently slowly moving bunker belt or a conveyor belt is used, or else a combination of such belts. The separating system of FIG. 3 shows a proportioning device as a combination of a bunker belt 20 with a flat conveyor 22. Small amounts of objects, in this case toothbrush bodies, fall from the bunker belt 20 onto the flat conveyor 22 over a certain height difference H. In this process, any objects that might be entangled with each other are knocked apart. The objects are fed to the selective separating system either intermittently or slowly continuously.

1. Separating system for elongated objects provided in bulk such as brush bodies, especially toothbrush bodies, comprising
a proportioning device; and
a selective transport means;
that proportioning device that delivers individual objects that have been separated from the group being combined with said selective transport means that conveys several jointly delivered objects at varying speeds, thus separating them.

2. Separating system according to claim 1, wherein the selectivity of said proportioning device is adjusted in such a way that regularly more than one just separated object is delivered to said selective transport device.

3. Separating system according to claim 1, wherein said selective transport device has a cascade of conveying segments.

4. Separating system according to claim 3, wherein there is a height difference between said consecutive conveying segments.

5. Separating system according to claim 3, wherein each of said conveying segments that follows in the transport direction runs faster than each of said conveying segments that preceded it.

6. Separating system according to claim 3 wherein each of said conveying segments that follows in the transport direction has a greater friction with respect to the objects than each of said conveying segments that preceded it.

7. Separating system according to one of claim 3, wherein at least one of said transport segments that is followed by at least one additional transport segment has an adjustable transport speed and is equipped with a passage detector for a transported object that causes the transport speed to be temporarily lowered when an object is detected.

8. Separating system according to one of claim 3, wherein said transport segments each have a transport belt.

9. Separating system according to claim 1, wherein said proportioning device is configured as a vibration bucket (10) that holds the group of objects.

10. Separating system according to one of claim 1, wherein said proportioning device is configured as a continuously or intermittently slowly moving conveyor belt or a bunker belt, or else a combination of both.
